(19) United States
(12) Patent Application Publication
(10) Pub. No.: US 2007/0284766 A1
(43) Pub. Date: Dec. 13, 2007

(54) Method for the Production of Nuclear Fuel Pellets

(76) Inventors: Andre Feugier, Chatuzange Le Goubet (FR); Luc De Tollenaere, Mol (BE); Veronique Peres, Hostun (FR); Marijn Gysen, Overpelt (BE)

Correspondence Address: KENYON & KENYON LLP, ONE BROADWAY, NEW YORK, NY, 10004, US

(21) Appl. No.: 10/577,748

(22) PCT Filed: Oct. 25, 2004
(86) PCT No.: PCT/FR04/02739

§ 371 Date: Jun. 18, 2007

(30) Foreign Application Priority Data
Oct. 29, 2003 (FR) 03 12687

(51) Int. Cl. G21C 21/00

(52) U.S. Cl. 264/.5

(57) ABSTRACT

A process for manufacturing nuclear fuel pellets through sintering of a material containing uranium dioxide obtained from a powder from a power originating from a process for a conversion of uranium hexafluoride.

### FIELD OF THE INVENTION

The invention relates to a method for the production of nuclear fuel pellets mainly containing uranium dioxide UO₂, used for the manufacture of fuel elements for a nuclear reactor.

### BACKGROUND INFORMATION

Fuel elements for nuclear reactors and in particular for pressurized water cooled nuclear reactors generally comprise long tubes closed at their extremities within which there are packed fuel pellets whose diameter is generally a little less than 10 mm and which are of a length between 10 mm and 20 mm.

The fuel pellets are obtained by the sintering, generally towards 1700° C., of a material mainly containing uranium dioxide UO₂ obtained from a powder originating from a process of the conversion of uranium hexafluoride UF₆.

Different processes for obtaining uranium oxides and in particular uranium dioxide UO₂ by conversion from uranium hexafluoride UF₆ are known. In particular a conversion process known as the “dry route conversion process” for gaseous uranium hexafluoride, a process in which uranium hexafluoride is pyrohydrolysed by steam, is known. Through this process oxides whose average composition can be expressed by the formula UO₂₊ₓ may be obtained. These oxides mainly comprise the dioxide UO₂ and other oxides such as U₃O₈ or U₃O₇ in variable proportions depending upon the manner in which the UF₆ conversion process is carried out, the powder obtained by dry route processes being a low density powder (density generally less than 1 g/cm³) comprising crystallites of very small dimensions (0.1 μm to 0.4 μm) which are agglomerated together to a greater or lesser extent. Such a powder has mediocre flowability (measured by normal flow tests).

In the context of the production of fuel pellets it is necessary to make raw pellets through the cold compression of granular material prior to sintering. Manufacture of the raw pellets by compression requires that the granular material be placed in deep narrow cylindrical dies at high rates in the case of industrial manufacture, so the granular material for manufacture of the raw pellets which are then sintered must have good flowability and properties which make it possible to obtain raw pellets which are sufficiently strong to withstand handling prior to sintering.

Various processes for improving the mechanical properties of the raw pellets are known (for example the addition of U₃O₈ powder of well-defined quality as described for example in French patent 2,599,883 and European patent 0249,549). These processes are generally based on the addition of a controlled quantity of an oxide such as U₃O₈ or U₃O₇ to the UO₂. Generally additives such as lubricants and pore-forming materials which assist shaping of the raw pellets and make it possible to control the porosity and density of the sintered fuel pellets also have to be incorporated with the granular material for manufacture of the raw pellets.

Uranium oxide powders obtained by uranium hexafluoride conversion processes and in particular dry route processes cannot be used for the manufacture of raw pellets without processing. Many operations are generally necessary in order to obtain a granular material having good flowability properties, having a density substantially greater than the density of the powder and having the desired characteristics in order to obtain good quality raw pellets. In particular the particle size of the powders has to be increased and rendered uniform in order to obtain particles of sufficient size and shape to improve flowability and compressibility.

Conventionally, the powders obtained directly by the dry route conversion process are first sieved in the conversion plant and/or the hard particles (for example fluorinated particles) retained during sieving are ground up, the powders are homogenised and loaded and stored with the view to use in the pellet-production unit, which may or may not be located close to the conversion unit.

The powders are then charged into the pelleting unit mixer with the incorporation of additives, in particular pore-forming additives, and then the powders and additives are mixed and homogenised and the mixture of powders is precompacted in a press in order to obtain pre-compacted material. The pre-compacted material is then subjected to a granulating operation in a grinder or granulator, and then to a spheroidising operation in an agitation vessel in order to obtain particles with a regular shape close to a spherical shape. Lubricant which is mixed with the particles by agitation is then added before compression is applied to obtain the raw pellets which will then be sintered.

The change from the powder which is directly obtained from the UF₆ conversion process to the particulate material which can be compressed into the form of raw pellets thus requires many operations which must all be carried out under satisfactory conditions in order that raw pellets and sintered pellets of good quality may be obtained. All these operations require many different devices such as mixers, pressers (or roller compacters) and granulating grinders, which suffer breakdown for many reasons. The main risk run is the failure of the sieve at the granulator outlet which is required to ensure a satisfactory uniform particle size for the particulate material used for the production of raw pellets. If a sieve fails, the products obtained have to be reprocessed to remove metal residues resulting from the destruction of the sieve and to ensure a suitable particle size for the pellet production operation.

Processes for the manufacture of uranium oxide powder by a wet route make use of processing through the spraying of a suspension are also known. The powders obtained by “wet route” processes have density and flowability characteristics which are superior to those of powders obtained by dry route processes and particle size characteristics which cannot currently be obtained directly by known dry route processes. However these powders must also undergo conditioning treatments before being shaped into raw pellets which are then sintered. Furthermore, it is increasingly desired that wet route processes should be replaced by dry route processes for reasons associated with safety and the environment, and it is becoming necessary to supply plants which conventionally use products obtained by a wet route with UO₂ powders obtained by a dry route.

In particular, in the case of the manufacture of a mixed MOX fuel comprising a mixture of uranium dioxide UO₂ and plutonium dioxide PuO₂, it is becoming necessary to supply manufacturing units with UO₂ powders obtained by a dry route.

The processes for the manufacture of mixed uranium and plutonium oxide pellets currently in use require the use of UO₂ powders of good flowability comprising granules which are preferably of regular shape, of high density, close to 2 g/cm³, and of a particle size controlled to a value below 250 μm in order to obtain a good mixture of uranium oxide and plutonium oxide, and properties which make it possible to obtain raw pellets having good mechanical strength.

In order to impart satisfactory density, flowability and particle size properties on dry route powders it has been suggested that a process of spray drying uranium oxide powders obtained by the dry route capable of industrial implementation could be used on a uranium oxide powder containing a limited concentration of ²³⁵U isotope.

It has also been suggested that in order to improve the flow, density and particle size properties of dry route powders granules could be manufactured by precompacting, followed by granulation. However the granulates obtained are too large (up to 1200 μm) to permit intimate mixing with plutonium oxide powder. Further granulation or grinding operations with sieving of the granulates must therefore be performed. Conventional grinding techniques adversely affect flow properties and reduce the density of the products. In addition to this the operations are complex and give rise to some hazard, given that the wires of the sieves used may fail, so that detritus may become mixed with the granulates, which could cause damage to the pellet-forming plant using the granulates. More generally, in addition to adding plutonium oxide PuO₂ in the context of the manufacture of MOX fuel it may be necessary to incorporate many additives into UO₂ powders obtained by a dry route. Such additives may for example be absorbent and moderating materials or fissile fuel materials such as ThO₂ or rare earth oxides such as Gd₂O3, Er₂O₃. In order to incorporate and mix such additives with UO₂ powder obtained by a dry route it is necessary to carry out prior conditioning treatments on the UO₂ powder, for example by homogenisation to a greater or lesser extent, or spray drying which may be followed by precompacting and granulation operations, these operations being themselves followed by one or more stages of grinding and/or sieving. These processes are therefore complex and require many stages for conditioning the UO₂ powder and for mixing it with additives.

As indicated above, in the case of the manufacture of fuels mainly based on uranium oxide UO₂, a mixture of UO₂ and U₃O₈ (or U₃O₇) is generally prepared in the proportions 80/20 or preferably 90/10. The U₃O₈ oxides used may be obtained directly by the dry route process by adjusting the conditions under which the pyrohydrolysis of UF₆ by steam takes place. U₃O₈ or U₃O₇ may also be obtained by the low temperature oxidation of UO₂ powder. The oxides U₃O₈ or U₃O₇ may be added to the starting powder or to the mixtures in the pelleting unit before the precompacting stage.

Other additives used to modify the microstructure of fuel pellets such as chromium oxide, alumina, silica, vanadium and niobium oxides or other compounds may be incorporated and mixed with the uranium dioxide obtained by a dry route at different stages in the process, which in all cases require that a particulate material having the desired characteristics for the manufacture of raw pellets be prepared. These incorporation and mixing operations may further complicate preparation of the particulate material.

Also it is generally necessary to use lubricants in some stages of the process, for example before precompacting and before compressing the particulate material into the form of raw pellets.

In particular the operations which must be performed prior to the manufacture of the raw pellets are many and complex, especially in the case where fine uranium oxide UO₂ obtained by a dry route process, which has little or no flowability, is used, where these processes have to replace the wet route process.

### SUMMARY

The objective of the present invention is therefore to provide a process for the manufacture of nuclear fuel pellets by sintering a material comprising uranium dioxide UO₂ obtained from a powder originating from a process for the conversion of uranium hexafluoride UF₆ through which the operations required to obtain a granular material comprising uranium dioxide UO₂ having suitable properties for the manufacture of raw pellets which are subsequently sintered can be simplified.

With this objective the powder directly obtained from a process for the conversion of uranium hexafluoride UF₆ is placed in a vessel containing moving compression and mixing bodies and the vessel is agitated so that the powder moves within the volume of the vessel in three non-coplanar axes in such a way as to be compressed between the moving bodies and between the moving bodies and the walls of the vessel until it forms a particulate material having a density of at least 1.7 g/cm³ in the uncompacted state and the particulate material obtained by agitation in the vessel is used to shape the raw fuel pellets for sintering, through compaction.

The process according to the invention may comprise the following features in isolation or in combination:
the vessel is subjected to three dimensional vibratory movement,
the powder placed in the vessel is obtained by a dry route conversion process and has a density of less than 1 g/cm³ and the density of the uncompacted particulate material obtained by agitation in the vessel is approximately 2 g/cm³;
the powder directly obtained by a UF₆ hexafluoride conversion process has a density of less than 1 g/cm³ and zero flowability as defined by a standard test of passage through a 15 mm orifice, and the particulate material obtained by agitation in the vessel has a flowability of more than 10 g/s after a few minutes agitation in the vessel,
the vessel containing the moving bodies and the powder directly obtained by a UF₆ hexafluoride conversion process are agitated for a period of between 1 and 600 minutes,
the moving compression and mixing bodies in the vessel are free bodies having any simple geometrical shape and a surface of low roughness,
the moving bodies are of cylindrical shape,
the moving bodies have the shape of substantially spherical beads,
the moving bodies are made of one of the following materials: sintered alumina Al₂O₃, sintered uranium oxide, sintered pure or doped zirconium oxide, tungsten carbide, steels, uranium metal or uranium/titanium alloy,
at least one additive comprising at least one core-forming agent is added to the vessel together with the uranium dioxide UO₂ powder obtained directly by a UF₆ hexafluoride conversion process in a proportion of at least 0.01% before the vessel is agitated,
at least one additive is placed in the vessel together with the uranium dioxide UO₂ powder obtained directly by a UF₆ hexafluoride conversion process,
the additive is placed in the vessel before the treatment of agitating the vessel is performed,
the additive is placed in the vessel in the course of the treatment of agitating the vessel,
the additive comprises at least one of the following substances: uranium oxide U₃O₈, uranium oxide U₃O₇, plutonium oxide PuO2, thorium oxide ThO₂, gadolinium oxide Gd₂O₃, pore-forming substance, lubricant, sintering doping agents,
for the manufacture of mixed uranium oxide-plutonium oxide (MOX) fuel pellets the vessel is placed in a confinement enclosure such as a glove box and uranium oxide and plutonium oxide powders and additives are placed in the vessel and the vessel is agitated in a manner controlled from the outside of the confinement enclosure,
prior to shaping the raw pellets by compression of the particulate material obtained by agitation in the vessel a lubricant material is added to the particulate material and the particulate material and the lubricant material are mixed in order to distribute the lubricating material over the particles of the particulate material,
the particulate material containing mainly uranium oxide UO₂ obtained by agitation of the conversion powder is mixed with the plutonium oxide powder PuO₂, in the presence of moving bodies prior to forming of the raw pellets for the manufacture of MOX fuel.

### DETAILED DESCRIPTION

To provide a better understanding of the invention several embodiments of the process according to the invention and the special means used for implementing them will be described.

One of the fundamental aspects of the process according to the invention is that it makes it possible to go in a single compression and mixing operation from a starting material obtained directly from a UF₆ conversion process to a particulate material which can be used for the manufacture of raw pellets by compression in the presses normally used for the manufacture of raw pellets.

The starting material is a uranium oxide powder mainly comprising UO₂ obtained directly by a process of the conversion of uranium hexafluoride UF₆ and more particularly by a dry route conversion process. Such a powder obtained from the outlet of the conversion unit has a composition which can be generally defined in the form UO_{2,+x}, this powder mainly comprising UO₂ and lesser quantities, which may be adjusted, of other oxides such as U₃O₈ and U₃O₇. The powder obtained from the outlet of the conversion unit comprises crystallites having dimensions between 0.1 μm and 0.4 μm which are partly agglomerated together in the form of aggregates of greater or lesser fragility of median size generally between 0.5 and 20 micrometres. The density of this powder is always less than 2 g/cm³ or even 1.5 g/cm³ and is most commonly less than 1 g/cm³ and of the order of 0.7 to 0.9 g/cm³. Such a powder has a flowability defined by a standard test of passage through a 15 mm orifice in a tapering container which is represented by a value in g/seconds of zero, the powder being incapable of flowing through the orifice in the context of the standard test.

All the densities indicated in this text (unless otherwise specified) are bulk densities measured using a standard test.

Such a low density, small particle size and zero flowability starting powder cannot be used in the process for the manufacture of raw pellets without processing.

When for example it consists of an UO₂ oxide powder obtained by the wet route the starting material is also unsuitable for the manufacture of raw pellets without intermediate processing.

The process according to the invention, which comprises only a single stage for passing from the starting powder as defined above to a particulate material having a density in the uncompacted state of over 1.7 g/m³ and good flowability is utilised in a vessel in which the starting powder and any additives are placed, as will be explained below. The vessel used generally has a steel wall lined internally with a layer of synthetic organic material, for example polyurethane, in order to reduce or eliminate the risks of abrasion of the vessel wall and contamination of the products placed in the vessel. The vessel wall generally has a shape obtained by revolution about an axis, for example a cylindrical shape or a toroidal shape. The vessel contains moving compressing and mixing bodies which are preferably free within the vessel and/or which may also be connected to the vessel, but in a manner in which they are able to move.

The vessel is movably mounted on a support and comprises movement means which make it possible to apply agitation such that the materials present in the vessel, for example the powder and the moving compression and mixing bodies, move throughout the volume of the vessel in three-dimensional movement, i.e. whose movement vectors have components along three axes which are not coplanar in space. Movements of material within the vessel may be caused only through agitation of the vessel or simultaneously through agitation of the vessel and lifting members located within the vessel.

The moving members located within the vessel are generally made of a hard metal or alloy or of a ceramic material. Preferably these moving bodies comprise alumina or uranium oxide sintered in such a way as to achieve the desired hardness to prevent contamination of the uranium oxide powder through materials which are likely to have an adverse effect on the properties of the powder or the pure pellets.

The moving compression and mixing bodies located within the vessel may have a great variety of shapes, such as cylindrical, spherical or cubic shapes; these moving bodies may for example comprise balls, rings, beads, cubes, cylinders with flat or hemispherical extremities, or disks, or bodies of any other shape.

The capacity of the vessel may vary widely without affecting the conditions under which the process is implemented. The capacity of the vessel may be from several kilos to several hundred kilos and even up to several tons, the capacity of the vessel corresponding to the maximum mass of the components which it may contain (powder and moving bodies).

According to the capacity of the vessel a number of parameters have to be adjusted in order to obtain the optimum conversion yield for the uranium oxide powder into particulate material for the manufacture of raw pellets. These parameters are in particular the moving bodies content which is defined as the ratio of the total volume of the moving bodies to the useful volume of the vessel, the powder filling ratio which is defined as the ratio of the total volume of the powder placed in the vessel to the useful volume of the vessel and the powder/moving body filling coefficient which is defined as the ratio of the total volume of powder placed in the vessel to the volume of the space between the moving bodies when the vessel is at rest.

In general the vessel is filled in such a way as to cover all the moving bodies and to fill the spaces between the moving bodies. Other filling conditions are also possible.

Preferably the vessel containing the mobile bodies is mounted on a fixed support in such a way that it can be caused to vibrate and comprises vibration drive means generally comprising an unbalanced motor.

In a particular embodiment which has proved satisfactory for the manufacture of a particulate material from UO₂ powder obtained by dry route conversion a grinder marketed under reference DM1 by the SWECO company has been used.

The grinder vessel has a wall of toroidal shape mounted with its vertical axis of revolution on a fixed support through vertical axis helical supporting springs. A vibrating motor is mounted rigidly on the vessel wall, with its axis along the vertical axis of the vessel. The motor is associated with imbalancing weights, such that when it is caused to rotate it drives the vessel in a three-dimensional oscillating vibratory movement, the axis of the vessel being subjected to a turning and oscillating movement simultaneously. The vessel encloses free moving bodies which may for example be of spherical or cylindrical shape or more complex shape, onto which the powder requiring treatment is poured before the motor agitating the vessel is placed in operation. The free moving bodies and the powder move under the effect of the movements and vibrations of the vessel, following three-dimensional trajectories filling a substantial part of the internal volume of the vessel. During the movements of the free moving bodies and the powder under the effect of the movements and vibration of the vessel the powder is compacted between the moving bodies and between the moving bodies and the walls of the vessel.

Unexpectedly, when a uranium oxide powder originating from a UF₆ dry route conversion process is placed in the SWECO DM1 grinder a continuing increase in the particle size of the powder is observed over time. The SWECO device is described by its manufacturer as a vibrating grinder which reduces the particle size of particulate material or powder to sub-micron dimensions down to 0.5 μm. The processing in this known device of dry route conversion powder having a density close to 0.8 g/cm³, comprising 0.1 μm to 0.4 μm crystallites bound together to a greater or lesser extent in the form of a mass, yields particles, through compression between the moving bodies, whose particle size becomes homogeneous over the course of time and lies between 10 μm and 150 μm. The density of the powder increases continually with treatment time within the vessel enclosing the moving bodies until after a period of the order of one to two hours it reaches a value of the order of 2 g/cm³. The flowability of the dry route conversion powder is zero, as indicated above, and after a few minutes treatment in the vessel containing the moving bodies subject to vibration the flowability of the particles becomes in excess of 10 g/sec and may very quickly reach very much higher values of up to 60 g/sec and more (values measured with the device mentioned above).

The particulate material obtained after one or two hours, and in some case up to 150 minutes, treatment in a vessel containing the moving bodies, can be used for the production of raw pellets by compression because of its density, its flowability and its compressibility which are due among other things to the shape of the particles obtained and their particle size.

Furthermore, treatment within the vibrating vessel containing moving bodies at the same time brings about intimate mixing of the uranium oxide powders obtained by the dry route conversion process and additives such as PuO₂, ThO₂, Gd₂O₃ and Er₂O₃ or again pore-forming agents such as organic or mineral materials which are likely to be destroyed during sintering or lubricants such as zinc or aluminium stearate or ethylene bistearamide or doping agents designed to modify the crystalline structure of the sintered pellets. Any other additive such as those mentioned above which can modify the structure and composition of the pellets may be incorporated with the mixture within the vessel.

Lubricants which also have a pore-forming effect and which are designed to replace conventional pore-forming agents, such as the product known by the name AZB or ammonium oxalate or its derivatives, may also be added to the mixture.

Additives may be incorporated with the oxide powder (generally comprising UO₂ and U₃O₈) wholly or partly at the time when the vessel is filled before starting treatment or at a particular time during treatment.

The lubricant or lubricants are added and mixed with grains which may or may not have already formed within the starting powder in order to obtain a lubricating effect during the subsequent stage of compaction.

The process according to the invention makes it possible to produce a fuel containing mainly uranium oxide UO₂ and other materials, for example neutron-absorbing materials such as gadolinium or erbium oxide or fissile fuel materials such as plutonium oxide or again fissile products such as thorium oxide. These products are added to the vessel at the desired time to achieve satisfactory incorporation of these materials with the particles formed from the uranium oxides from the powder obtained by UF₆ conversion.

In the case of toxic and/or radioactive materials, such as plutonium oxide, it is of course necessary to take the precautions known to those skilled in the art. However use of the process according to the invention which makes it impossible to obtain particulate material for the production of raw pellets in a single operation within a single vessel enclosing moving compression bodies makes it possible to perform these operations easily without risk to the operators by placing the vessel within a protective enclosure such as a glove box, the operations of preparing the charge, addition and vibration of the vessel being capable of being controlled from the outside of the glove box.

In the case of a preferred embodiment the moving compression and mixing bodies are wholly free within the interior of the vessel and constitute a part of the charge placed in the vessel. In this case the compression bodies, for example beads or cylinders, are first placed in the vessel in a predetermined quantity. The powder directly obtained from the UF₆ and conversion process and if appropriate different additives are then added. The vessel is then set in motion and preferably in vibrational movement. The moving bodies remain permanently within the vessel, the treated material is discharged through a grid located at the base of the vessel.

In accordance with a preferred embodiment the moving bodies within the vessel are of very hard alumina Al₂O₃. When the process according to the invention is implemented the kinetic energy communicated to the moving bodies bringing about compression of the powder is moderate so that the energy used in impacts between the moving bodies and between the latter and the walls of the vessel is low. The moving compression and mixing bodies therefore suffer very limited destruction and because of this there is little contamination of the powders by materials originating from the moving compression bodies. Furthermore the addition of small quantities of alumina to the fuel pellets causes no disadvantages, and aluminium can even provide beneficial effects. Measurements made further indicate that this contamination by aluminium does not exceed a few parts per million.

When sintered uranium oxide UO₂ moving bodies are used instead of alumina, the risk of contamination by elements which were not present in the uranium oxide powder is wholly eliminated. Furthermore the treatment time is reduced by increasing the kinetic energy because of the high density of the sintered uranium oxide bodies (theoretical density 10.96 g/cm³). However the addition of uranium to the powder in the form of sintered uranium oxide substantially reduces the sinterability of the mixture, because of some deterioration in the moving bodies, and does not bring about other substantial advantages.

A number of embodiments will be described to provide a better understanding of the invention.

Three embodiments of the invention will be described below as examples nos. 1, 2 and 3 together with a comparative example.

The characteristic stage in the process according to the invention comprising treating powders obtained directly by a dry route conversion process in a vessel containing moving bodies in order to obtain a particulate material which can be used for the production of raw pellets is carried out in a vibrating grinder marketed under reference DM1 by the SWECO company.

In the case of the four examples the toroidally-shaped vertical axis grinding vessel contained 20 kg of moving bodies consisting of sintered alumina cylinders approximately ½″ (12.7 mm) in diameter and length. When carrying out the treatment the powder was poured onto the moving compression bodies which were wholly free within the vessel. The vessel was then placed in vibrational movement by powering the imbalanced motor attached to the vessel.

### EXAMPLE 1

Several charges of particulate material were prepared in succession from uranium oxide UO₂ originating from a UF₆ hexafluoride dry route conversion process. In order to prepare eight charges in a first series, 10 kg of material in the form of powder containing 89% by weight of uranium oxide UO₂, 6% of UROX and 5% of U₃O₈, to which were added 0.2% of ethylene bistearamide and 0.55% of ammonium oxalate were placed in the vessel of the grinder containing alumina moving bodies.

In order to prepare eight charges in a second series, a material having the same composition as the eight charges in the first series, to which were added 0.2% ethylene bistearamide and 0.47% ammonium oxalate were placed in the vessel successively.

The product known by the name UROX is a uranium oxide U₃O₈ obtained from uranium oxyfloride UO₂F₂ during the conversion of UF₆ in order to obtain uranium oxides, or from UO₂ oxide in a high temperature furnace.

The U₃O₈ oxide added in the mixture with UROX is recovered in fuel pellets in the course of production or after production of the pellets.

Each of the charges in the first series of charges and each of the charges in the second series was agitated in the vessel in such a way that the charge and the moving bodies moved in all directions in space.

After a treatment time of the order of 120 minutes, a granular material mainly comprising uranium oxides having the following characteristics was found in the vessel:

Mean density in the uncompacted state (DNT): approximately 2.2 g/cm³.

Mean density in the compacted state (DT): approximately 2.9 g/cm³.

Mean flowability: approximately 57 g/s.

The particles in each of the series of eight charges were homogenised in a mixer so as to have uniform properties (in particular densities and flowability centered on the values indicated above).

In order to homogenise the charges in each of the two series of charges the eight charges of particles were placed in a rotating vessel mixer normally used in nuclear fuel pellet manufacturing plants and the vessel was caused to rotate.

Preferably the mixer vessel has a biconical shape. Such a vessel generally called a double cone mixer is conventionally used in plants for the production of nuclear fuel.

A double cone having a capacity of at least 80 kg into which the eight charges in each of the series of charges was placed was used, and then the double cone was caused to rotate for approximately 5 minutes in order to obtain a uniform particulate material having the mean characteristics indicated above.

It is quite obvious that, in industrial application of the invention, when an agitation vessel with moving bodies of sufficient capacity (for example 80 kg) is available, agitation of the starting mixture of powders can be carried out in a single operation in order to obtain a mass of uniform particulate material without further homogenising treatment in the double cone.

However the double cone is used, either after homogenisation of the charges, or after agitation of the powders in a large capacity vessel, to mix a lubricant with the particulate material.

In the case where the double cone is used to homogenise charges, the lubricant is added to the homogenised charge in the double cone and where the entire mass of particulate material is obtained in a single operation the particulate material is transferred into a double cone and the lubricant is added.

0.25% by weight of ethylene bistearamide is for example added to the particulate material. The lubricant is mixed with the particulate material by causing the double cone vessel to rotate for approximately 1 minute 30 seconds.

The ethylene bistearamide selected as lubricant is preferably used in the form of the commercial product CIREC from the HOECHST company, which has the requisite particle size to ensure optimum lubrication.

However as agitation in the presence of moving bodies gives rise to an interaction and a “hard” mixture of the substances present has a tendency to reduce or destroy the lubricating effect of the substance added by way of lubricant.

In order to achieve satisfactory lubrication conditions it may therefore be necessary to produce a “soft” mixture of particles and lubricant in a mixing device such as a double cone.

Inadequate lubrication is reflected by increased compression forces and grinding due to rubbing of the particles during compression.

A homogenised and lubricated particulate material having a DNT of approximately 2.4 g/cm³ and a DT of approximately 2.9 g/cm³ was obtained. The flowability of the particulate mixture was approximately 80 g/s.

The two charges of particulate material obtained from mixes which only differed in the proportion of pore-forming material (ammonium oxalate) in the starting material had identical properties and were subsequently placed in a pelleting press to bring about compression of the particulate material in order to obtain raw pellets.

The raw pellets had satisfactory strength properties.

The raw pellets obtained from the first charge (containing 0.55% of pore-forming agent) had a density of 6.3 g/cm³ and the raw pellets from the second charge (containing 0.47% of pore-forming material) a density of 5.8 g/cm³.

Addition of the pore-forming agent made it possible to achieve the required sintered density (95%).

The lubricant was correctly dispersed through the particulate material in both cases. No grinding was observed during compression.

The stage of agitating the mixture of powders in the presence of moving bodies made it possible to obtain a particulate material whose density in the uncompacted state and the compacted state is very substantially greater than the density of the starting powder mainly comprising uranium oxide UO₂ originating from a dry route conversion process for uranium hexafluoride UF₆.

The stage of mixing with a lubricant made it possible to increase the density very slightly (at least in the uncompacted state) and to substantially increase the flowability of the particulate material.

### EXAMPLE 2

5 kg of uranium dioxide UO₂ powder obtained by a dry route having a density of 0.9 g/cm³, this powder obtained directly by the UF₆ conversion process being incapable of flowing through a 15 mm orifice, was placed in the vessel containing moving alumina bodies. No pore-forming agent or lubricant was added to the charge of UO₂ powder and the treatment was started by causing the vessel containing the charge to vibrate.

Particulate material was taken during the course of treatment after 10, 15, 30, 60 and 120 minutes respectively, the treatment terminating after 120 minutes.

The densities and the flowabilities of the particulate material were measured, as above by sieving, and the results are shown in Table 2 below.

TABLE 2

| | Method of filling: 20 kg of | | | | | | | |
|---|---|---|---|---|---|---|---|---|
| | alumina grinding medium (11 × 13 mm) | | | | | | | |
| | | | Treatment time | | | | | |
| TESTS | | | min | | | | | |
| N° 2 | | | 0 | 10 | 15 | 30 | 60 | 120 |
| Density | DNT | g/cm³ | 0.9 | 1.3 | 1.3 | 1.5 | 1.8 | 2.1 |
| | DT | g/cm³ | 1.6 | 1.9 | 1.9 | 2.1 | 2.4 | 2.6 |
| Flowability | 15 mm cone | g/s | 0 | 0 | 42 | 58 | 66 | 79 |

Density in the uncompacted condition increased from the value of 0.9 g/cm³ to the value of 2.1 g/cm³ during two hours treatment. Flowability increased sharply after 15 minutes treatment to reach a value of 79 g/s at the end of treatment.

As previously the particulate material obtained from the treatment was compressed in dies used to obtain raw pellets. In order to carry out this operation a lubricant to aid compression of the particles in the form of raw pellets was mixed with the particles. (A pore-forming material was added to the particulate material if necessary prior to compression to adjust the density of the sintered pellets to a desired value).

### EXAMPLE n° 3

TABLE 3

Method of filling: 20 kg of
alumina grinding medium (11 × 13 mm)

Treatment time

| TESTS | | | min | |
|---|---|---|---|---|
| N° 2 | | | 0 | 60 |
| Density | DNT | g/cm³ | 1.1 | 2.1 |
| | DT | g/cm³ | 1.8 | 2.6 |
| Flowability | 15 mm cone | g/s | 0 | 65 |

4 kg of uranium dioxide UO₂ powder obtained by a dry route, of density 0.8 g/cm³, the powder being incapable of flowing through a 15 mm orifice, and then 2 kg of a mixture of uranium oxides containing 25% gadolinium oxide (Gd₂O₃) as well as 36 g of pore-forming material comprising an organic substance were charged into the vessel containing the compression bodies of cylindrical shape. Treatment was stopped after one hour, the powder comprising the uranium and gadolinium oxide mixture which had a density of 1.1 g/cm³ at the time of the start of treatment had a density of 2.1 g/cm³ after one hour's treatment. This powder had good flowability of 65 g/s.

18 g of a lubricant comprising zinc stearate was added to the powder. The particulate material mixed with the lubricant was then directly compacted and shaped into raw pellets which were then sintered using the conventional process.

### COMPARATIVE EXAMPLE

A uranium oxide UO₂ powder obtained directly by the dry route conversion process having a density of 0.85 g/cm³ in the uncompacted state was placed in a knife grinder such as is used for the treatment of powders in the conversion plant in accordance with the process according to the prior art.

After treatment in the knife grinder the density of the powder was unchanged or had even decreased slightly to reach a value of 0.8 g/cm³. The flowability of the powder, which was zero at the start, remained zero on completion of treatment in the knife grinder.

The examples according to the invention therefore show that the process according to the invention using an agitation vessel containing moving bodies and preferably free moving bodies can substantially increase the density of a powder obtained by a dry route conversion process to reach a value close to or slightly above 2 g/cm³. In addition to this the treatment makes it possible to obtain a particulate material having very good flowability which can be easily shaped into raw pellets using conventional processes.

The sintered raw pellets have properties which are those of fuel pellets manufactured by processes according to the prior art.

Furthermore the tests carried out showed that additives can be added to the uranium oxide powders obtained by the dry route process either before starting treatment in the vessel or during treatment or at the end of treatment in the vessel. When using organic pore-forming materials it is generally necessary to add more than 0.1% by weight of pore-forming material to the treatment vessel with the uranium oxide, and in all cases more than 0.01%. As each additive or other material has its own pore-forming effect, knowing the final density which has to be obtained and the sintered density of the matrix without additives, the quantity of additives and pore-forming material which has to be added in order to obtain the desired sintered density is calculated. The process according to the invention which comprises only a single stage (or at most two stages if a lubrication stage by a “soft” mixture is taken into account) to pass from the uranium oxide powder obtained by a uranium hexafluoride conversion process to a particulate material which can be shaped into raw pellets, instead of the seven stages in the case of the prior process, brings about considerable simplification in the procedures and equipment used for the manufacture of nuclear fuel.

Lubricant and the particulate material may be mixed in devices other than mixers of a double cone type; such devices must provide a “soft” mixture so as not to destroy the lubricant.

The invention applies to the production of fuel pellets of extremely varied composition.

In the case of the production of pellets for MOX fuel, containing uranium oxides (mainly UO₂) and plutonium oxide PuO₂, the plutonium oxide may be added to the mixture prior to agitation treatment in the presence of moving bodies or to the particulate material obtained by the agitation treatment in the grinder vessel. The plutonium oxide in powder form may be mixed with the particulate material in a powder.

One or more lubricants selected from a large number of substances which may be added to the particulate material prior to shaping of the raw pellets may be used. In particular these lubricants may for example by ethylene bistearamide or ADS (aluminium distearate).

1-17. (canceled)

18. A process for manufacture of nuclear fuel pellets through sintering of a material containing uranium dioxide UO₂ obtained from a powder originating from a process for a conversion of uranium hexafluoride UF₆, comprising:
obtaining the powder directly by the UF₆ hexafluoride conversion process;
placing the powder in a vessel containing moving compressing and mixing bodies;
agitating the vessel such that the powder moves within a volume of the vessel in three noncoplanar axes to be compressed between moving bodies and walls of the vessel to form a particulate material having a density in an uncompacted state of at least 1.7 g/cm³; and
shaping the particulate material obtained by agitation in the vessel into raw fuel pellets that undergo sintering.

19. The process according to claim 18, wherein the vessel is subjected to three-dimensional vibratory movement.

20. The process according to claim 18, wherein the powder placed in the vessel is obtained by a dry route conversion process and has a density of less than 1 g/cm³ and the density of the particulate material obtained by agitation in the vessel is approximately 2.0 g/cm³ in an uncompacted state.

21. The process according to claim 18, wherein the powder obtained directly by the UF₆ hexafluoride conversion process has a density of less than 1 g/cm³ and a flowability of zero as defined by a standard test of passage through a 15 mm orifice and in that the particulate material obtained by agitation in the vessel has a flowability of more than 10 g/s after three minutes agitation in the vessel.

22. The process according to claim 18, wherein the vessel containing the moving bodies and the powder obtained by a UF₆ hexafluoride conversion process is agitated for a time between 1 and 600 minutes.

23. The process according to claim 18, wherein the moving compression and mixing bodies in the vessel are free bodies having any simple geometrical shape and a surface of low roughness.

24. The process according to claim 23, wherein the moving bodies are cylindrically shaped.

25. The process according to claim 23, wherein the moving bodies are substantially spherical beads.

26. The process according to claim 18, wherein the moving bodies are one of sintered alumina Al₂O₃, sintered uranium oxide, pure sintered zirconium, doped sintered zirconium oxide, tungsten carbide, steels, uranium metal and uranium/titanium alloy.

27. The process according to claim 18, wherein before the vessel is agitated at least one additive comprising at least one pore-forming agent in a proportion equal to at least 0.01% is added to the vessel together. with the uranium dioxide UO₂ powder obtained directly by the UF₆ hexaflouride conversion process.

28. The process according to claim 27, wherein at least one additive is added to the vessel together with uranium dioxide UO₂ powder obtained directly by the UF₆ hexaflouride conversion process.

29. The process according to claim 28, wherein the additive is placed in the vessel before performing the treatment through agitation of the vessel.

30. The process according to claim 29, wherein the additive is placed in the vessel in a course of treatment by agitation of the vessel.

31. The process according to claim 28, wherein the additive comprises at least one of uranium oxide U₃O₈, uranium oxide U₃O₇, plutonium oxide PuO₂, thorium oxide ThO₂, gadolinium oxide Gd₂O₃, pore-forming substance, lubricant, and sintering doping agents.

32. The process according to claim 18, wherein mixed uranium oxide-plutonium oxide fuel pellets are produced, further comprising:
placing the vessel in a confinement enclosure;
placing the uranium oxide, plutonium oxide powders and additives in the vessel; and
agitating the vessel in a manner that is controlled from outside the containment enclosure.

33. The process according to claim 18, further comprising:
adding a lubricant material to the particulate material prior to shaping the pellets by compression of the particulate material obtained by agitation in the vessel; and
preparing a soft mixture of the particulate material and the lubricating in order to distribute the lubricating material over the particles of the particulate material.

34. The process according to claim 32, further comprising:
mixing the particulate material comprising uranium oxide UO₂ obtained by agitation of the conversion powder in a presence of moving bodies with the plutonium oxide powder PuO₂ before shaping of the pellets for the production of mixed uranium oxide plutonium oxide fuel pellets.
